(19) United States
(12) Patent Application Publication
(10) Pub. No.: US 2011/0052911 A1
(43) Pub. Date: Mar. 3, 2011

(54) ADHESIVE TAPE WITH A VISCOELASTIC POLYOLEFIN BACKING

(75) Inventors: Sven Hansen, Hamburg (DE); Bernhard Müssig, Seevetal (DE); Dennis Seitzer, Hamburrg (DE)

(73) Assignee: tesa SE, Hamburg (DE)

(21) Appl. No.: 12/989,819

(22) PCT Filed: May 29, 2009
(86) PCT No.: PCT/EP09/56629

§ 371 Date: Nov. 19, 2010

(30) Foreign Application Priority Data
May 30, 2008 (DE) 10 2008 025 983.7

(51) Int. Cl. C09J 7/02; B32B 37/00

(52) U.S. Cl. 428/339; 428/343; 428/354; 156/327

(57) ABSTRACT

The invention relates to an adhesive tape with a viscoelastic backing consisting of an olefin polymer with a density of between 0.86 and 0.89 g/cc and a crystallite melting point of at least 105° C., and also consisting of an adhesive resin.

This application is a 371 of PCT/EP2009/56629, filed May 29, 2009, which claims priority of DE 10 2008 025 983.7, filed May 30, 2008.

The invention relates to an adhesive tape having a viscoelastic carrier, comprising a specific olefin polymer and to the use thereof for adhesive tapes which adhere very strongly on both sides.

For industrial pressure-sensitive adhesive tape applications it is very common to use double-sided pressure-sensitive adhesive tapes in order to join two materials to one another. Differentiation takes place, according to type, between single-layer double-sidedly self-adhesive tapes and multilayer double-sidedly self-adhesive tapes.

Single-layer double-sidedly self-adhesive tapes, referred to as transfer tapes, are constructed such that the pressure-sensitive adhesive layer that forms the single layer contains no carrier and is lined only with suitable release materials, examples being siliconized release papers or release films. Transfer tapes may be lined on one side or both sides with release materials. Often, release papers or release films with different levels of siliconization on either side are used in order to allow the transfer tape to be readily wound into a roll and then also readily applied. Adhesive transfer tapes are frequently used in order to impart tack to a wide variety of different substrates. This is done, for example, by laminating the transfer tape onto the substrate. The release paper then remains as a lining to the pressure-sensitive adhesive layer in the product.

Thinner transfer tapes are often produced from solution with self-adhesives; thicker transfer tapes are often produced with self-adhesives from the melt or by means of what is called UV polymerization. In this case, a prepolymerized syrup of acrylate monomers is coated between two UV-transparent, antiadhesively coated release films and is crosslinked on the web by UV irradiation. Mention may be made, by way of example, of the specifications U.S. Pat. No. 4,181,752 A1, EP 0 084 220 A, EP 0 202 938 A, EP 0 277 426 A and U.S. Pat. No. 4,330,590 A1. A disadvantage of this technology is the often high residual monomer fraction in the self-adhesives. For many applications this is unacceptable. Transfer tapes filled with UV-opaque adjuvants cannot be produced in this way.

DE 43 03 183 A1 describes a process for producing thick pressure-sensitive adhesive layers, especially for producing high-performance self-adhesive articles. A mixture of starting monomers which can be polymerized by means of UV radiation is mixed with a solvent-free, saturated, photopolymerizable polymer and thickened in the process, after which this mixture is applied to a adhesively treated carrier and is irradiated with UV radiation. A disadvantage is the use of copolymerized or added photoinitiators, since the layers may yellow and, on UV exposure prior to use, an often marked change in the adhesive properties is observed. In that case it is necessary—by means of UV-opaque packaging, for example—to go to considerable effort and expense in order to provide the customer with consistently high bonding performance. Furthermore, in the case of bonding to UV-transparent substrates as for example to window glass or transparent plastics surfaces, there is a risk of postcrosslinking of photoinitiator-containing layers. Although this produces an initial rise in the bond strength, the layers then become paintlike and undergo embrittlement, as a result of further crosslinking. Sooner or later, this leads to the failure of the bond, particularly under a shearing load.

Transfer tapes may be foamed or filled in order to improve their properties, particularly, for example, in respect of bonding to uneven substrates. DE 40 29 896 A1 describes a carrierless, double-sided self-adhesive tape comprising a pressure-sensitive adhesive layer more than 200 μm in thickness, comprising solid glass microballs of more than 1.5 g/cm³ in density. This tape is said to exhibit particularly effective adhesion. A disadvantage is the high density as a result of the glass balls that are used.

Double-sided adhesive tapes of multilayer construction have advantages over their single-layer counterparts, since the variation of the individual layers allows specific properties to be set. For instance, a three-layer adhesive tape, consisting of a middle carrier layer and two outer layers, can be constructed symmetrically or asymmetrically. The two outer layers may each be pressure-sensitive adhesive layers, or, for example, one layer may be a pressure-sensitive adhesive layer and the other layer may be a heat-activatable adhesive. The carrier, i.e., the middle layer, may be, for example, a film, a woven fabric, a “non-woven” material (nonwoven web) or a foam film carrier. Foams or foamlike carriers are often used when there is a requirement for high bond strength to uneven surfaces or when spacings are to be compensated.

For instance, for adhesive assembly tapes, it is common to use closed-cell foam carriers based on PE (polyethylene), PU (polyurethane) or EVA (ethyl-vinyl acetate), which have a double-sided application of pressure-sensitive synthetic-rubber adhesive or pressure-sensitive acrylate adhesive. Applications for these tapes are, for example, the bonding of mirrors, of trim strips and badges in automotive construction, and other uses in automobile construction, and also use in the furniture industry or in household appliances.

Assembly tapes for the outdoor sector generally possess pressure-sensitive adhesives based on polyacrylate. This material is particularly weathering-resistant and very long-lived, and is virtually inert toward UV light and toward degradation by oxidation or ozonolysis. Also known are adhesive assembly tapes with middle layers of rubber, styrene block copolymers, and polyurethane. None of these materials possesses the same good aging stability and heat stability properties as polyacryate. Systems based on acrylate block copolymers are resistant to aging but are not sufficiently heat-resistant for high-performance requirements, since these systems are crosslinked only physically by way of styrene or methyl methacrylate domains. When the softening temperature of the domains is reached (as in the case of styrene block copolymers), the pressure-sensitive adhesives undergo softening. Consequently, the bond fails.

Another disadvantage of typical foam adhesive tapes is that they can easily split. If, for example, PE foam is used, this material softens on heating to about 100° C., and the bond fails. Double-sidedly adhesive assembly tapes of this kind are unsuitable for high-grade applications.

Foams based on PU are indeed more temperature-stable, but have a tendency to yellow under UV and sunlight exposure. They too are often unsuitable for high-performance applications.

For a number of years there have been double-sided adhesive tapes available which are of three-layer construction with an acrylate core. This viscoelastic acrylate core is foamlike. Its foamlike structure is achieved through the admixing of hollow glass or polymer balls to the acrylate composition or else the acrylate composition is foamed by means of expandable polymeric microballoons. Provided adjacent to this viscoelastic elastic layer in each case are pressure-sensitive adhesives, based in the majority of cases likewise on acrylate, rarely on synthetic rubber, or else, in special cases, on heat-activatable adhesive layers. The advantages of the viscoelastic acrylate core arise on the one hand from the physical properties of the polyacrylate (which, as already mentioned, are a particular weathering stability and long life, and substantially inert behavior toward UV light and toward degradation by oxidation or ozonolysis). As a result of the design of the acrylate core layer, determined for example by the comonomer composition, the nature and proportion of certain fillers, and the degree of crosslinking, these products are especially suitable for bonding articles to substrates having uneven surfaces. Depending on the choice of the pressure-sensitive adhesive, a broad spectrum of properties and bond strengths can be covered.

Nevertheless, as a result of their preparation, the aforementioned systems have critical disadvantages. The viscoelastic acrylate core layer is prepared by a process of two-stage UV polymerization. In the first step of that process a mixture based on acrylate monomers, 10% by weight acrylic acid and 90% by weight isooctyl acrylate, for example, is prepolymerized to a conversion of approximately 10% to 20% by UV irradiation in a reactor in the presence of a photoinitiator. Alternatively, this “acrylic syrup” may also be obtained by thermally initiated free radical polymerization. In the second step, this acrylic syrup, often after further photoinitiator, fillers, hollow glass balls, and crosslinker have been added, is coated between antiadhesively coated UV-transparent films, and is polymerized to a higher degree of conversion on the web, by means of further UV irradiation, and in the course of this polymerization it is crosslinked. The completed three-layer product is obtained, for example, after the pressure-sensitive adhesive layers have been laminated on.

The production of “thicker” viscoelastic layers in particular must in many cases be carried out in the absence of oxygen. In that case the composition is protected by a lining of film material, and UV initiation takes place through the films. PE and PP films which are sometimes used for this purpose deform under the conditions of crosslinking reaction (in the case of UV initiated polymerization, heat of reaction is liberated, and can cause deformation of non-temperature-resistant film) and are therefore not very suitable. UV-transparent films such as PET are more thermally stable; in this case, however, it is necessary to add to the composition a photoinitiator which reacts to longwave radiation, in order for the reaction to take place. As a consequence of this, these layers have a tendency to undergo aftercrosslinking under UV light or sunlight. This process negates the advantage specific to the polyacryate as a material. A further disadvantage is that fillers not transparent to UV cannot be used. Moreover, as a result of the process, there remains a high residual monomer fraction in these products. Possible reduction in residual monomer through a reduction in coating speed or through intensive subsequent drying is not very economic. The maximum achievable layer thickness is very heavily dependent on the wavelength of the photoinitiator used. Layers can be produced to about 1 mm, albeit with the disadvantages specified above. Layers any thicker than this are virtually impossible to obtain.

A particular disadvantage in the case of acrylate layers produced by two-stage UV polymerization, UV crosslinking or electron-beam irradiation is a more or less strongly pronounced profile of crosslinking through the layer. Toward the irradiation source, the UV-crosslinked layer is always more strongly crosslinked than on the side opposite the UV radiation source. The degree of the crosslinking profile is dependent, for example, on the layer thickness, on the wavelength of the photoinitiator that is used, and also on the wavelength of the radiation emitted by the UV radiation source.

Specifications DE 198 46 902 A1 and DE 101 63 545 A1 propose using electron-beam or UV irradiation from both sides in order to lower the resulting crosslinking profile and to provide virtually homogeneous crosslinking of thick UV-crosslinkable pressure-sensitive acrylate adhesive layers in particular. However, the layers produced in this way still have a crosslinking profile, and, furthermore, the process is very costly and inconvenient. Moreover, it would be virtually impossible to use in order to produce viscoelastic acrylate carriers; instead, the preparation of pressure-sensitive adhesive layers in particular is described.

A disadvantage of viscoelastic acrylate carriers which exhibit a profile of crosslinking through the layer is their inadequate capacity for distributing stresses in a uniform way. One side is always either overcrosslinked or undercrosslinked. An exact balance can never be struck between adhesive and cohesive properties for the entire layer, but instead only for a small section.

Thick noncrosslinked acrylate carriers can be extruded. If crosslinking agents are added, in order to produce a crosslinked acrylate carrier, the process is very difficult, since crosslinking must not take place in the course of extrusion, and at the end of the process it is expected that the viscoelastic acrylate carrier is crosslinked.

Thick acrylate carriers have only very limited UV transparency, especially those which have been UV-crosslinked (on account of the absorbing photoinitiator). It is therefore not possible, using single-sided UV irradiation, to crosslink both layers of adhesive simultaneously and to the same extent.

It is an object of the invention, accordingly, to provide an adhesive tape which does not have the abovementioned disadvantages and which is notable for technical adhesive properties that are at least as good, and which can be utilized, in particular, as an adhesive assembly tape. Furthermore, the viscoelastic carrier in the adhesive tape ought to be able to be produced solventlessly and ought to be stable toward UV- and heat-induced aging.

This object is achieved by means of an adhesive tape having a viscoelastic, polyolefin-based carrier, as recorded in the main claim. Advantageous developments of the subject matter of the invention, and uses of the adhesive tape, are found in the dependent claims.

The invention accordingly provides an adhesive tape having a carrier comprising a specific olefin polymer and comprising a tackifier resin, and optionally having one or two adhesives as outer layer on the carrier, the olefin polymer having a density of between 0.86 and 0.89 g/cm³ and a crystallite melting point of at least 105° C.

### BRIEF DESCRIPTION OF THE DRAWINGS

The invention will now be described in greater detail with reference to the drawings, wherein:

FIG. 1 depicts an L-jig; and

FIG. 2 depicts an L-jig adhered with the inventive adhesive tape to a polyethylene (PE) test plate.

The skilled worker considered olefin polymers to be unsuitable for viscoelastic carriers, owing to the hardness or excessively low melting point of the raw materials, and, consequently, such carriers have to date been produced from soft acrylate polymers in solid-mass or foamed form. As carriers in an adhesive assembly tape, for example, the requirement is for viscoelastic properties similar to those of high-grade PSAs (pressure-sensitive adhesives). Surprisingly, nevertheless, from olefin polymers having a density of between 0.86 and 0.89 g/cm³, preferably between 0.86 and 0.88 g/cm³, more preferably between 0.86 and 0.87 g/cm³, and a crystallite melting point of at least 105° C., preferably at least 115° C., more preferably at least 135° C., and from a tackifier resin, it is possible to obtain functioning viscoelastic carriers.

The olefin polymer of the invention preferably has a melt index of less than 8 g/10 min, more preferably less than 1.5 g/10 min. The flexural modulus of the olefin polymer is preferably less than 50 MPa, more preferably less than 26 MPa, and more particularly less than 17 MPa.

The polypropylene resin may have been synthesized in a variety of ways: for example, as a block copolymer, as a graft polymer or as what is called a reactor blend, as in the case of heterophase polyolefins (for example, impact polypropylene, also called—not entirely correctly, but commonly—polypropylene block copolymer).

The olefin polymer preferably comprises ethylene or propylene and at least one further comonomer selected from C₂ to C₁₀ olefins, preferably C₂ to C₁₀ α-olefins. Particularly suitable are copolymers of propylene and ethylene, propylene and but-(1)-ene, and ethylene and oct-(1)-ene, and also terpolymers of ethylene, propylene and but-(1)-ene.

The density of the olefin polymer is determined in accordance with ISO 1183 and expressed in g/cm³. The melt index is tested in accordance with ISO 1133 under 2.16 kg and is expressed in g/10 min. The test temperature, as is familiar to the skilled worker, is 230° C. for propylene-based polyolefins and 190° C. for ethylene-based polymers. The flexural modulus is to be determined in accordance with ASTM D 790 (secant modulus at 2% strain). The crystallite melting point (T_{cr}) and the heat of fusion are determined by DSC (Mettler DSC 822) at a heating rate of 10° C./min in accordance with ISO 3146. Where two or more melt peaks occur, the peak with the highest temperature is selected, since only melt peaks above 100° C. will be retained, and effective, in carrier formulations, whereas melt peaks considerably below 100° C. will not be retained and will have no effect on the properties of the product. The heat of diffusion determines first the bond strength and tack of the formulation and secondly the shear strength particularly under hot conditions (i.e., 70° C. and above). The heat of fusion of the polyolefin is therefore significant for the ideal compromise in the technical adhesive properties; it is preferably between 3 and 18 J/g, more preferably between 5 and 15 J/g.

The heat of fusion of the carrier is therefore likewise significant for the ideal compromise in terms of the technical adhesive properties, and is preferably between 1 and 6 J/g, more preferably between 2 and 5 J/g.

The olefin polymer of the invention may be combined with elastomers such as natural rubber or synthetic rubbers. It is preferred to use unsaturated elastomers such as natural rubber, SBR, NBR or unsaturated styrene block copolymers only in small amounts or, with particular preference, not at all. Synthetic rubbers with saturation in the main chain, such as polyisobutylene, butyl rubber, EPM, HNBR, EPDM or hydrogenated styrene block copolymers are preferred in the case of a desired modification.

The carrier, surprisingly, has better mechanical properties when it comprises a tackifier resin.

The polydispersity is the ratio of weight average to number average in the molar mass distribution and can be determined by means of gel permeation chromatography; it plays an important part as far as the properties are concerned. Tackifier resins used are therefore those having a polydispersity of less than 2.1, preferably less than 1.8, more preferably less than 1.6. The highest tack is achievable with resins having a polydispersity of 1.0 to 1.4.

In respect of tackifier resin it has emerged that resins based on rosin (for example balsam resin) or on rosin derivatives (for example, dispropionated, dimerized or esterified rosin), preferably in partially or fully hydrogenated form, are highly suitable. Among all tackifier resins, they have the greatest tack. This is probably due to the low polydispersity of 1.0 to 1.2. Like the hydrogenated resins, terpene-phenolic resins are notable for a particularly high aging stability.

Preference is likewise given to hydrocarbon resins, which are highly compatible presumably on account of their polarity. These resins are, for example, aromatic resins such as coumarone-indene resins or resins based on styrene or α-methylstyrene or on cycloaliphatic hydrocarbon resins from the polymerization of C₅ monomers such as piperylene, from C₅ or C₉ fractions from crackers, or terpenes such as β-pinene or δ-limonene, or combinations thereof, preferably in partially or fully hydrogenated form, and hydrocarbon resins obtained by hydrogenation of aromatics-containing hydrocarbon resins or cyclopentadiene polymers.

Additionally it is possible for resins based on polyterpenes, preferably in partially or fully hydrogenated form, and/or terpene-phenolic resins to be used.

The amount of tackifier resin is preferably 130 to 350 phr, more preferably 200 to 240 phr (phr denotes parts by weight: 100 parts by weight of resin or rubber, in this case olefin polymer).

For the purpose of adjustment of the desired viscose properties, the carrier may comprise a liquid plasticizer such as, for example, aliphatic (paraffinic or branched), cycloaliphatic (naphthenic) and aromatic mineral oils, esters of phthalic, trimellitic, citric or adipic acid, lanolin, liquid rubbers (for example, low molecular mass nitrile, butadiene or polyisoprene rubbers), liquid polymers of isobutene homopolymer and/or isobutene-butene copolymer, liquid resins and plasticizer resins having a melting point below 40° C., based on the raw materials of tackifier resins, especially the above-recited classes of tackifier resin. Particular preference among these is given to liquid polymers of isobutene and/or butene and esters of phthalic, trimellitic, citric or adipic acid, particularly the esters thereof with branched octanols and nonanols.

Instead of a liquid plasticizer it is also possible to use a very soft and virtually noncrystalline olefin polymer. This is preferably an elastomeric homopolymer of isobutene (for example, Oppanol), a copolymer of ethylene, propylene, but-1-ene, hex-1-ene and/or oct-1-ene, which are known, for example, under the trademarks Exact®, Engage®, Versify® or Tafmer®, or a terpolymer of ethylene, propylene, but-1-ene, hex-1-ene and/or oct-1-ene, the flexural modulus being preferably below 20 MPa, the crystallite melting point being preferably below 50° C., and the density being preferably between 0.86 and 0.87 g/cm³. Further preferred olefin polymers are EPDM, i.e., terpolymers of ethylene and propylene and a diene such as ethylidenenorbornene, preferably having an ethylene content of 40% to 70% by weight, a

Mooney viscosity (conditions 1+4, 125° C.) of below 50 and/or a density of below 0.88 g/cm³, more preferably below 0.87 g/cm³. Since such olefin polymers are indeed very soft, as compared with a liquid plasticizer, the amount in relation to the olefin polymer of the invention ought to be very high, in other words well above 100 phr.

Particular preference is given to an adhesive tape having a viscoelastic carrier without migratable plasticizers.

The melting point of the tackifier resin (determination in accordance with DIN ISO 4625) is likewise significant. Typically, the bond strength of a rubber composition (based on natural or synthetic rubber) increases in line with the melting point of the tackifier resin. With the olefin polymer of the invention, the opposite appears to be true. Tackifier resins with a high melting point of 115° C. to 140° C. are significantly less favorable than those having a melting point below 105° C., which are preferred. Resins having a melting point of below 85° C. are not widely available commercially, since the flakes or pellets cake together in transit and on storage. In accordance with the invention, therefore, it is preferred to combine a customary tackifier resin (having a melting point from the range 85° C. to 105° C., for example) with a plasticizer in order to achieve a de facto reduction in the resin melting point. The mixed melting point is determined on a homogenized mixture of tackifier resin and plasticizer, with the two components being present in the same proportion as in the carrier. This melting point is preferably in the range from 45° C. to 95° C.

Conventional layers based on natural rubber or unsaturated styrene block copolymers as elastomer component typically comprise a phenolic antioxidant in order to prevent the oxidative degradation of this elastomer component with double bonds in the polymer chain. The carrier layer of the invention, however, comprises an olefin polymer without oxidation-sensitive double bonds, and could therefore manage without antioxidant. For a high long-term stability, therefore, it is preferred to use a primary antioxidant and more preferably a secondary antioxidant as well. In the preferred embodiments the carriers comprise at least 2 phr, more preferably 6 phr, of primary antioxidant, or preferably at least 2 phr, more particularly at least 6 phr, of a combination of primary and secondary antioxidants, although the primary and secondary antioxidant function need not be present in different molecules but may also be combined within one molecule. The amount of secondary antioxidant is preferably up to 5 phr, more preferably 0.5 to 1 phr. Surprisingly it has been found that a combination of primary antioxidants (for example, sterically hindered phenol or C radical scavengers such as CAS 181314-48-7) and secondary antioxidants (for example, sulfur compounds, phosphites or sterically hindered amines) produces an improved compatibility. Preference is given in particular to the combination of a primary antioxidant, preferably sterically hindered phenol having a relative molar mass of more than 500 daltons, with a secondary antioxidant from the class of the sulfur compounds or from the class of the phosphites, preferably having a relative molar mass of more than 500 Daltons, with the phenolic, sulfur-containing and phosphitic functions being present not necessarily in three different molecules, but also, possibly, as a combination of more than one function in one molecule.

In applications where the adhesive tape is exposed for a relatively long time to the light (for example, to insolation), it is preferred to use a light stabilizer, more preferably a HALS such as Tinuvin 111, a UV absorber such as Tinuvin P or opaque pigment).

In order to optimize the properties it is possible for the viscoelastic carrier employed to be blended with further additives such as fillers, fibers, flame retardants, pigments, dyes, antiozonants, photoinitiators, conductivity additives, ferromagnetic additives, crosslinking agents or crosslinking promoters and, in particular, blowing agents for foaming. Suitable fillers and pigments are, for example, carbon black, titanium dioxide, wood flour, calcium carbonate, zinc carbonate, zinc oxide, silicates or silica. Preferred fillers are solid or hollow balls of glass or polymers, and gas-expandable microballoons, preferably in an amount of 2% to 6% by weight, based on the overall formula of the carrier.

Additionally possible are carriers in which no plasticizers or other additives or adjuvants are used.

The viscoelastic carrier can be prepared and processed from solution and from the melt. Preferred preparation and processing methods take place from the melt. For the latter case, suitable preparation processes encompass not only batch processes but also continuous processes. Particularly preferred is the continuous manufacture of the viscoelastic carrier by means of an extruder or compounder, with subsequent coating onto an in-process liner, or a liner which remains in the product, with or without the additional application of an adhesive. Coating methods preferred are extrusion coating with slot dyes, and calender coating.

The adhesive tape is preferably lined on one or both sides with a liner. The liner for the product or the in-process liner are, for example, a release paper or release film, preferably having a release coating. Liner carriers contemplated include, for example, films of polyester or polypropylene, or calendered papers, with or without a dispersion coating or thermoplastic coating.

The viscoelastic carrier preferably has a thickness of between 100 and 5000 μm, more preferably between 500 and 3000 μam and very preferably between 800 and 1200 μm.

The probe tack of the adhesive tape is preferably at least 2 N, more preferably at least 4 N, very preferably at least 5 N.

The value in the L-jig test on polyethylene is preferably at least 100 N/25 mm, more preferably at least 200 N/25 mm.

The 90° bond strength to polyethylene is preferably at least 5 N/cm, more preferably at least 10 N/cm, very preferably at least 15 N/cm.

The 90° bond strength to steel is preferably at least 20 N/cm, more preferably at least 30 N/cm, very preferably at least 50 N/cm.

The adhesive tape of the viscoelastic carrier of the invention is considerably superior to the known products in respect of adhesive properties, and not only to polyethylene but also to steel, as witnessed by the examples.

Depending on the glass transition temperature of the olefin polymer and on the design of the formula, carriers for strongly adhering products can be obtained with a glass transition temperature (measured by DMA at 10 rads/s) of −20° C. to −50° C.; preferably, the glass transition temperature is below −20° C., more preferably below −35° C., in order to obtain good bonding performance under low-temperature conditions. Known viscoelastic carriers of acrylate have glass transition temperatures in the range from +5° C. to −15° C., and hence adhesive tapes manufactured therefrom are difficult to bond at low temperatures, and at very low temperatures, indeed, the bond is sensitive to impact.

In contrast to the acrylate carriers hitherto customary the viscoelastic carrier need not be crosslinked, since below the crystallite melting point of the olefin polymer there is a physical crosslinking. Therefore, in contrast to radiation-crosslinked carriers, there is no upper limit on thickness. For applications at very high temperatures, however, the carrier can also be crosslinked with radiation such as gamma rays or, preferably, electron beams, the voltage being preferably at least 250 kV and the dose being preferably at least 20 kGy, more preferably at least 50 kGy.

The surface(s) of the carrier may be chemically or physically pretreated with an adhesive prior to coating, in other words, for example, covered with a primer (adhesion promoter) or subjected to a corona treatment. One preferred embodiment of the subject matter of the invention has a barrier layer on one surface, preferably on both surfaces, in order to prevent migration of components of the carrier and/or of the adhesive. Examples thereof are coatings of epoxy resins with hardeners such as Polyment NK 380 or polyamides, or lamination with thin sheets of metal, polyester or acrylonitrile copolymer (for example Barex), for example.

The adhesive tape is formed by application to the viscoelastic carrier, partially or over the whole area, preferably to one and more preferably to both sides, of an adhesive or different adhesives. This can be done, for example, by coating the carrier with a composition or vice versa, or by lamination.

One preferred embodiment of the subject matter of the invention is a viscoelastic carrier which inherently has pressure-sensitive adhesive properties and therefore does not have to be provided with an adhesive.

In another preferred embodiment of the subject matter of the invention it is laminated or coated externally, on one side or, preferably, both sides, with a pressure-sensitive adhesive, more preferably of acrylate. Suitable PSAs are based on natural or synthetic rubber, (for example, styrene block copolymers, SBR or polyisobutylene), silicone, and, preferably, acrylate, and may be applied from solution, from dispersion, and, preferably, from the melt. They may comprise tackifier resins, plasticizers and other additives, of the type described above for the viscoelastic carrier.

The carrier may also be provided on one or both sides with a sealable composition.

The general expression “adhesive tape” for the purposes of the invention encompasses all sheetlike structures such as two-dimensionally extended films or film sections, tapes with extended length and limited width, tape sections, die cuts, labels, and the like.

The adhesive tape of the invention exhibits outstanding properties of a kind which could not have been foreseen by the skilled worker, and, consequently, the tape can be used in particular as an adhesive assembly tape for high-performance applications. On account of the high flexibility of the carrier, the adhesive tape conforms very well to uneven substrates. A permanent bond is produced between adhesive tape and substrate, and does not fail even under high shearing forces and bending moment stresses or even at elevated temperatures or even after exposure to UV radiation or humidity. An adhesive tape of this kind can be used, for example, in the automobile, construction or furniture industries, where mirrors, strips, badges or trim are to be durably bonded. On account of the outstanding properties of the product, it is used advantageously in numerous sectors of industry as an adhesive assembly tape, where different surfaces, especially UV-transparent surfaces such as window glass or transparent plastics, are to be durably bonded to one another. The carrier may also be high transparent, in which case the size of the crystals of the olefin polymer is preferably below 100 nm. An olefin polymer of this kind can be prepared with a zirconium-based metallocene catalyst. In that case the carrier preferably has a haze value, measured in accordance with ASTM D 1003, of below 8 (measured on moldings 2 mm thick, in cyclohexanol).

The invention is illustrated below through a number of examples, without wishing thereby to restrict the invention.

### Test Methods:

Test conditions: 23° C.+/−1° C. and 50%+/−5% relative humidity.

90° Bond Strength, Steel and PE

The bond strength to steel and to PE is determined under test conditions of 23° C.+/−1° C. room temperature and 50%+/−5% relative humidity. The specimens are cut to a width of 20 mm and adhered to a plate made of VA steel (steel DIN EN 10088-2, type 1.4301, design type 2R, roughness depth 30 to 60 nm, Thyssen-Krupp) or to a PE plate (HDPE, PE-13A3, Thyssen), respectively. The test plates must be cleaned and conditioned prior to measurement. For this purpose, the steel plate is first wiped with acetone and then left in the air for five minutes to allow the solvent to evaporate. The PE test plate is cleaned with ethanol and dried for five hours in a controlled-climate area.

The side of the tape facing away from the test substrate is lined with a 36 μm etched polyester film, thereby preventing the specimen from stretching in the course of the measurement. After that, the test specimen is rolled onto the test plate. For this purpose, a 2 kg roller is rolled five times back and forth over the adhesive tape, with a rolling speed of 10 m/min. Immediately after roller application, the steel plate is inserted into a special mount, which allows the specimen to be peeled off vertically upward at an angle of 90°. The bond strength is measured at a speed of 300 mm/min using an electronic tensile testing machine.

The measurement result is averaged from three measurements and is reported in N/cm.

L-Jig Test

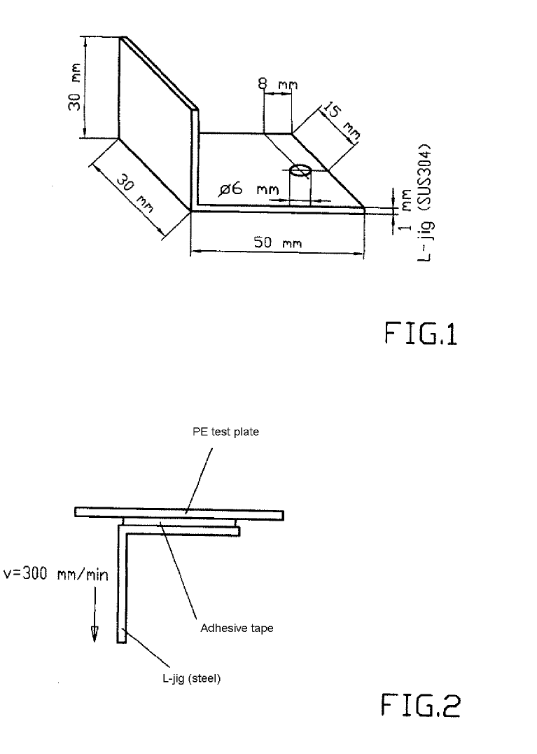

Five test specimens are cut to a square size, with an edge length of 25 mm, from the adhesive tape under test. The PE test plate, made of HDPE (as described above) are cleaned with ethanol and dried for five hours in a controlled-climate area. The L-jigs (steel DIN EN 10088-2, steel type 1.4301×5 CrNi 18-10, Thyssen-Krupp) are stored in acetone for 30 minutes and then wiped down a number of times with an acetone-soaked cloth on the side to which bonding is to take place. Thereafter they are left to evaporate for 10 minutes. The test specimens are adhered to the L-jig by their side which is not to be tested. During this adhering, it is necessary to ensure that one bonding side is flush with the free end of the L-jig. The L-jig is then, as shown in FIGS. 1 and 2, adhered centrally onto the PE test plate.

The L-jigs are pressed with a pressing force of 60 N for five seconds. The test specimens are then conditioned at 40° C. for the specified adhering time of three days. With the aid of a tensile testing machine, the specimens thus prepared are subjected to dynamic testing at room temperature, with a speed of 300 mm/min.

The adhesive bond is intended to part adhesively between test plate and adhesive tape. The maximum force measured at this point is reported as the result, in N/25 mm. The average value is calculated from five individual results.

Probe Tack

Using the probe tack method, the adhesive behavior of a double-sidedly adhesive tape is characterized by means of a TA.XT2i texture analyzer from Stable Micro Systems.

In the method, a probe with cylindrical steel die is advanced vertically onto the adhesive at a predetermined test speed until a defined pressing force is reached, and, after a defined contact time, is removed again, once more at a predetermined speed. During this operation, the force expended for pressing or detaching, respectively, is recorded as a function of the travel.
Instrument:
   TA.XT2i texture analyzer from SMS (Stable Micro Systems Ltd.) or
   TA.XT plus texture analyzer from SMS (Stable Micro Systems Ltd.)
   Measuring head/force probe: 5 kg with 0.001 to 50 N measuring range
Tack die:
   Standard: cylinder (stainless steel): Ø 2 mm
Test conditions:
   Standard: 23±1° C./50±5% relative humidity

The test plate with polished stainless steel surface is first cleaned with acetone and then conditioned at RT for around 30 minutes. The sample is then bonded to the smooth and precleaned side of the steel plate, without bubbles and in a defined way, by rolling a 2 kg roller back and forth three times at 150 mm/s. To adhere the adhesive strip fully to the substrate, the plate is subsequently stored in a controlled-climate area at 23° C. and 50% relative humidity for 12 hours. In the course of this storage, the surface to be measured must be lined with a siliconized release paper. The steel die as well is cleaned in acetone and conditioned at RT for 30 minutes. The release paper is not removed from the adhesive strip until immediately before measurement.

The steel plate is screwed firmly in the sample platform, and adjusted under the die.

The test parameters to be selected are as follows:
Tack die: cylinder (VA steel): Ø2 mm
Pre-test speed: 0.1 mm/s
Test speed: 0.1 mm/s
Trigger force: 0.05 N
Data density: 400 pps
Removal speed (post-test speed): 1.5 mm/s
Contact time: 5 seconds
Pressing force: 5 N

Before each individual measurement, the sample platform must be positioned beneath the probe and screwed firmly. The distance between the measurement locations is three times the diameter of the die.

For each sample, ten individual measurements are carried out in order to calculate the average. The die is not normally cleaned between the individual measurements, except where there are deposits on the die or where there is a distinct trend apparent in the measurement series. An average is formed from the measurements made.

The measurement plot (graphic representation of the force [N] as a function of the travel [mm]) is used to determine the maximum force, and this figure is termed the probe tack.

### Raw Materials in the Examples

IN FUSE 9107: Copolymer of ethylene and oct-1-ene, melt index 1 g/10 min, density 0.866 g/cm³, flexural modulus 15.5 MPa, crystallite melting point 121° C.
IN FUSE 9507: Copolymer of ethylene and oct-1-ene, melt index 5 g/10 min, density 0.866 g/cm³, flexural modulus 13.9 MPa, crystallite melting point 119° C.
Softell CA02: Copolymer of propylene and ethylene, melt index 0.6 g/10 min, density 0.870 g/cm³, flexural modulus 20 MPa, crystallite melting point 142° C., heat of fusion 9.9 J/g
NOTIO PN-0040: Copolymer of propylene and but-1-ene (possibly with small amounts of ethylene as well), melt index 4 g/10 min, density 0.868 g/cm³, flexural modulus 42 MPa, crystallite melting point 159° C., heat of fusion 5.2 J/g
Engage 7467: Copolymer of ethylene and but-1-ene, melt index 1.2 g/10 min, density 0.862 g/cm³, flexural modulus 4 MPa, crystallite melting point 34° C.
LD 251: LDPE, melt index 8 g/10 min, density 0.9155 g/cm³, flexural modulus 180 MPa, crystallite melting point 104° C.
Ondina 933: White oil (paraffinic-naphthenic mineral oil)
Wingtack 10: Liquid C₅ hydrocarbon resin
Indopol H-100: Polyisobutene-polybutene copolymer having a kinematic viscosity of 210 cSt at 100° C. to ASTM D 445
PB 0300 M: Polybutene, melt index 4 g/10 min, density 0.915 g/cm³, flexural modulus 450 MPa, crystallite melting point 116° C.
Escorez 1310: Nonhydrogenated C₅-hydrocarbon resin, melting point of 94° C., polydispersity 1.5
Dertophene DT 110: Terpene-phenolic resin, melting point 115° C., polydispersity 1.4
Wingtack extra: Aromatics-modified C₅-hydrocarbon resin, melting point 97° C., polydispersity 1.6
Regalite R1100: Hydrogenated aromatic hydrocarbon resin, melting point 100° C., polydispersity 1.9
Foral 85: Fully hydrogenated glycerol ester of rosin, having a melting point of 85° C. and a polydispersity of 1.2
Irganox 1726: Phenolic antioxidant with sulfur-based function of a secondary antioxidant
Irganox 1076: Phenolic antioxidant
Tinuvin 111: HALS light stabilizer
Q-Cel 5025: Hollow glass balls

### Example 1

The carrier consists of the following components:

100 phr NOTIO PN-0040,

78.4 phr Ondina 933,

212 phr Escorez 1310,

2 phr Irganox 1726.

The mixture is prepared continuously in an extruder and is applied at 900 g/m² using a roll applicator to an in-process liner. Prior to winding, a second in-process liner is laminated in. The viscoelastic carrier is sufficiently tacky for adhesive data to be determined (see below). The in-process liners are then removed and the viscoelastic carrier is laminated with a liner which remains in the product.

### Example 2

Preparation takes place as in example 1, but the formula for the carrier is as follows:

100 phr NOTIO PN-0040,

78.4 phr Wingtack 10,

212 phr Foral 85,

2 phr Irganox 1076.

### Example 3

Preparation takes place as in example 1, but the formula for the carrier is as follows:

100 phr IN FUSE 9107,

78.4 phr Ondina 933,

212 phr Dertophene DT 110,

2 phr Irganox 1076.

### Example 4

Preparation takes place as in example 1, but the formula for the carrier is as follows:

100 phr IN FUSE 9507,

78.4 phr Wingtack 10,

212 phr Escorez 1310,

2 phr Irganox 1076.

### Example 5

Preparation takes place as in example 1, but the formula for the carrier is as follows:

100 phr IN FUSE 9107,

78.4 phr Ondina 933,

212 phr Wingtack extra,

2 phr Irganox 1076.

### Example 6

Preparation takes place as in example 1, but the formula for the carrier is as follows:

100 phr Softell CA02A,

70 phr Indopol H-100,

200 phr Regalite R1100,

2 phr Irganox 1726,

15 phr Q-Cel 5025,

1 phr Tinuvin 111

The carrier is crosslinked from both sides using electron beams (dose 20 kGy, voltage 350 kV).

### Examples 7 to 11

The product construction corresponds to examples 1 to 5, but the carrier is laminated on both sides with 100 g/m² of an acrylate composition per side. In the case of example 7, the carrier, in accordance with example 1, before being laminated, is additionally provided with a polyamide varnish barrier layer in a thickness of 2 μm.

The acrylate composition is prepared as follows:

A reactor conventional for free-radical polymerizations is charged with 45 kg of 2-ethylhexyl acrylate, 45 kg of n-butyl acrylate, 5 kg of methyl acrylate, 5 kg of acrylic acid, and 66 kg of acetone/isopropanol (92.5:7.5). After nitrogen gas has been passed through the reactor for 45 minutes with stirring, the reactor is heated to 58° C. and 50 g of AIBN added. The external heating bath is then heated to 75° C. and the reaction is carried out constantly at this external temperature. After one hour a further 50 g of AIBN are added, and after four hours dilution takes place with 20 kg of acetone/isopropanol mixture. After five hours and again after seven hours, initiation is repeated with 150 g of bis-(4-tert-butylcyclohexyl) peroxydicarbonate each time. After a reaction time of 22 hours, the polymerization is discontinued and the batch is cooled to room temperature. The polyacrylate has a conversion of 99.6%, a K value of 59, a solids content of 54%, an average molecular weight of M_{w}=557 000 g/mol, polydispersity PD (M_{w}/Mₙ)=7.6. The acrylate polymer solution is freed from the solvent under reduced pressure, using an extruder, and in a second step is blended in a ratio of 70 parts by weight of acrylate polymer to 30 parts by weight of Dertophene DT 1100, and also with an epoxy crosslinker and an amine accelerator.

### Comparative Example 1

3M PT 1100, multilayer polyacrylate with hollow glass balls in an internal layer, outer layers of polyacrylate and tackifier resin

### Comparative Example 2

Nitto Hyper Joint 9008, one-layer polyacrylate with hollow glass balls

### Comparative Example 3

3M 4950, three-layer polyacrylate with hollow glass balls in the internal layer, outer layers of polyacrylate

### Comparative Example 4

3M 4910, one-layer polyacrylate without hollow glass balls

### Comparative Example 5

3M GT 6008, one-layer polyacrylate with hollow glass balls

### Comparative Example 6

The preparation takes place as in example 5, but IN FUSE 9107 is replaced by LD 251.

### Comparative Example 7

The preparation takes place as in example 5, but IN FUSE 9107 is replaced by Engage 7467. The coating is very soft and sticky like a fly paper. Bond strength cannot be measured, owing to cohesive fracture.

### Comparative Example 8

The preparation takes place as in example 5, but Ondina 933 is replaced by PB 0300 M. The coating has virtually no tack and is not elastic.

### Overview of the Results

| | | Bond | Bond | |
|---|---|---|---|---|
| | | strength | strength | |
| | Probe tack | 90° to steel | 90° to PE | L-jig PE |
| | [N] | [N/cm] | [N/cm] | [N/25 mm] |
| Example | | | | |
| 1 | 4.9 | 33 | 22 | 202 |
| 2 | 9.9 | >50 | 30 | 296 |
| 3 | 5.6 | — | — | 297 |
| 4 | 8.2 | >50 | — | 322 |
| 5 | 4.3 | >50 | 29 | 266 |
| 6 | 5.2 | >50 | — | 210 |
| 7 | — | 33 | — | 155 |
| 8 | — | 30 | 17 | 176 |
| 9 | — | 34 | 12 | 185 |
| 10 | — | 31 | — | 169 |
| 11 | — | >50 | — | 170 |
| Comparative | | | | |
| example | | | | |
| 1 | 2.5 | 24 | 3 | 146 |
| | | | | (carrier |
| | | | | splits) |
| 2 | 2.0 | 16 | 1 | — |
| 3 | 1.4 | 12 | 2 | — |
| 4 | 1.2 | 12 | 2 | — |
| 5 | 1.2 | 11 | 0.7 | 83 |

1. An adhesive tape comprising a viscoelastic carrier comprising an olefin polymer having a density of between 0.86 and 0.89 g/cm³ and a crystallite melting point of at least 105° C. and comprising a tackifier resin.

2. The adhesive tape as claimed in claim 1,wherein
the density of the olefin polymer is between 0.86 and 0.88g/cm³, and/or the olefin polymer has a crystallite melting point of at least 105° C.

3. The adhesive tape as claimed in claim 1, wherein
the olefin polymer has a melt index of less than 8 g/10 min, and/or
has a flexural modulus of less than 50 MPa.

4. The adhesive tape as claimed in claim 1, wherein
the olefin polymer comprises propylene or ethylene and at least one further comonomer selected from the C₂ to C₁₀ olefins.

5. The adhesive tape as claimed in claim 1, wherein the carrier comprises
a primary antioxidant, and/or
a secondary antioxidant in an amount of 0 to 5 phr, and/or
a light stabilizer, and/or
a UV absorber.

6. The adhesive tape as claimed in claim 1, wherein
the carrier comprises a tackifier resin which has a polydispersity of less than 2.1.

7. The adhesive tape as claimed in claim 1, wherein
the tackifier resin is selected from the group
of resins based on rosin or rosin derivatives,
of hydrocarbon resins based on C₅ monomers,
of hydrocarbon resins from hydrogenation of aromatics-containing hydrocarbon resins,
of hydrocarbon resins based on hydrogenated cyclopentadiene polymers, and/or
of resins based on polyterpenes,
of terpene-phenolic resins,
the amount of tackifier resin in the adhesive being 130 to 350 phr.

8. The adhesive tape as claimed claim 1, wherein
the carrier comprises a plasticizer selected from the group of mineral oils, of liquid polymers of isobutene homopolymer and/or isobutene-butene copolymer, and of esters of phthalic, trimellitic, citric or adipic acid.

9. The adhesive tape as claimed in claim 1, wherein
the carrier comprises a copolymer or a terpolymer of ethylene, propylene, but-1-ene, hex-1-ene and/or oct-1-ene, the flexural modulus of the copolymer or terpolymer being below 20 MPa and/or the crystallite melting point being below 50° C., and/or the density being between 0.86 and 0.87 g/cm³, or comprises an EPDM, having an ethylene content of 40% to 70% by weight and/or a density below 0.88 g/cm³, the amount of copolymer or terpolymer being above 100 phr.

10. The adhesive tape as claimed in claim 1, wherein
the carrier has a thickness of between 100 and 5000 μm.

11. The adhesive tape as claimed in claim 1, wherein
the carrier is not provided with any pressure-sensitive adhesive, or
the carrier is provided externally on one side or on both sides with a pressure-sensitive adhesive comprising acrylate.

12. The adhesive tape as claimed in claim 1, wherein
the 90° bond strength to polyethylene is at least 5 N/cm.

13. The adhesive tape as claimed in claim 1, wherein
the probe tack of the adhesive tape is at least 2 N.

14. Method of bonding parts of an assembly comprising bonding said parts with an adhesive tape as claimed in claim 1.
